(19) United States
(12) Patent Application Publication
(10) Pub. No.: US 2025/0384005 A1
(43) Pub. Date: Dec. 18, 2025

(54) HETEROGENEOUS COMPUTATION PLATFORM FOR HIGH DEFINITION DISTRIBUTED ACOUSTIC FIBER SENSING

(71) Applicant: NEC Laboratories America, Inc., Princeton, NJ (US)

(72) Inventors: Azita NOURI, HIGHLAND PARK, NJ (US); Yuheng CHEN, SOUTH BRUNSWICK, NJ (US); Junqiang HU, DAVIS, CA (US); Shuji MURAKAMI, MONMOUTH JUNCTION, NJ (US); Yue-Kai HUANG, PRINCETON, NJ (US); Ting WANG, WEST WINDSOR, NJ (US)

(73) Assignee: NEC Laboratories America, Inc., Princeton, NJ (US)

(21) Appl. No.: 19/218,660

(22) Filed: May 27, 2025

Related U.S. Application Data
(60) Provisional application No. 63/652,332, filed on May 28, 2024.

(51) Int. Cl. G06F 13/40; G01H 9/00

(52) U.S. Cl. CPC G06F 13/4022; G01H 9/004

(57) ABSTRACT

Disclosed are systems and methods for distributed fiber optic sensing (DFOS)/distributed acoustic sensing (DAS) that circumvent traditional data path(s) from an analog-to-digital converter (ADC) to a central processor (CPU). In sharp contrast to the prior art, systems and methods according to aspects of the present disclosure employ a direct peripheral component interconnect express (PCIe) connection to graphics processing unit (GPU) random access memory (RAM). This inventive architecture eliminates any need for data to pass through the CPU, thereby facilitating data acquisition streaming and enabling real-time processing of significantly larger data sets than is possible with contemporary DFOS systems.

### CROSS REFERENCE TO RELATED APPLICATIONS

This application claims the benefit of U.S. Provisional Patent Application Ser. No. 63/652,332 filed May 28, 2024, the entire contents of which is incorporated by reference as if set forth at length herein.

### FIELD OF THE INVENTION

This application relates generally to distributed fiber optic sensing (DFOS) systems, methods, and structures. More particularly, it pertains to improved DFOS/Distributed Acoustic Sensing (DAS) systems and methods employing a heterogeneous computation platform for high definition DAS.

### BACKGROUND OF THE INVENTION

As those skilled in the art will understand and appreciate, distributed acoustic sensing (DAS) systems have traditionally implemented a two-level distributed hierarchy: the Interrogator plus an edge computer. The Interrogator, containing an FPGA processing unit, is tasked with handling data acquisition and preliminary digital signal processing. The resulting data is then transmitted to a higher-level computer for further analysis, including detection, pattern classification, and localization.

As a high throughput sensing system, the DAS system is expected to function optimally. Yet, due to the limitations in FPGA hardware resources and the bandwidth of data links between computation units, the system often resorts to down sampling the measurement results. This compromise significantly reduces the capability of the DAS system for a number of practical applications, including rendering it inadequate for certain new applications that demand high-definition data acquisition over long ranges.

### SUMMARY OF THE INVENTION

An advance in the art is made according to aspects of the present disclosure directed to distributed fiber optic sensing (DFOS)/distributed acoustic sensing (DAS) systems that utilize a novel approach which circumvents traditional data path(s) from an analog-to-digital converter (ADC) to a central processor (CPU). In sharp contrast to the prior art, systems and methods according to aspects of the present disclosure employ a direct peripheral component interconnect express (PCIe) connection to graphics processing unit (GPU) random access memory (RAM). This inventive architecture eliminates any need for data to pass through the CPU, thereby facilitating data acquisition streaming and enabling real-time processing of significantly larger data sets than is possible with contemporary DFOS systems.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing an illustrative multi-threaded real time data processing system for DFOS including the integration of ADC with GPU-accelerated computation and dual-buffers “ping-pong” memory management for optimized throughput and latency according to aspects of the present disclosure.

FIG. 3 is a schematic diagram showing illustrative one iteration of computation for one sample per location according to aspects of the present disclosure.

FIG. 4 is a plot showing illustrative results for systems and methods according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

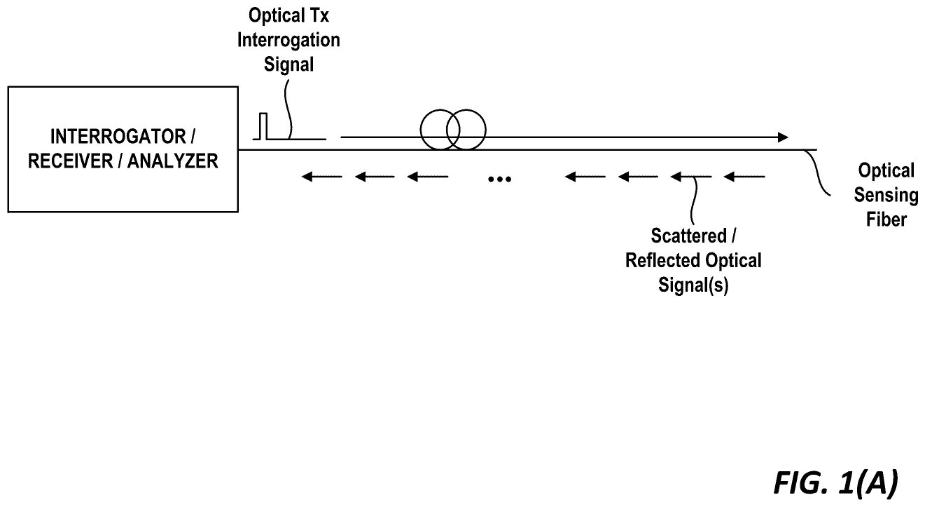

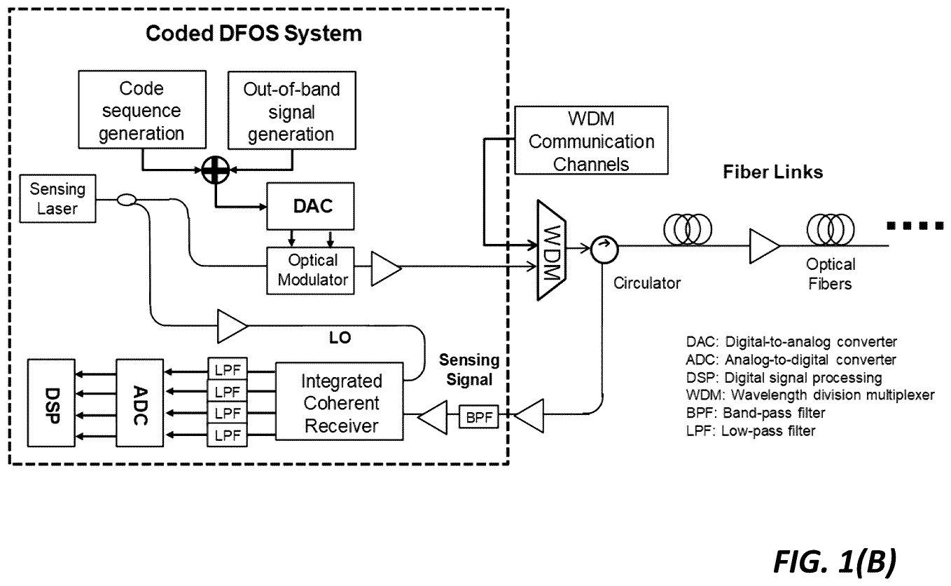

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detect/analyze reflected/backscattered and subsequently received signal(s). The signals received are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration or an indication of temperature.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

As previously noted, a basic principle behind the DFOS is that optical fiber cable conditions such as a change of strain or temperature on the optical fiber cable can influence the properties of the light signal traveling through an optical fiber. When pulsed light is launched into an optical fiber sensing cable, a small fraction of light is backscattered, and its properties are influenced by the fiber cable condition. The backscattered light includes three types of scattering: Raman scattering, Brillouin scattering, and Rayleigh scattering. This methodology gauges alterations in Rayleigh scattering intensity via interferometric phase beating. With coherent detection, the DFOS system retrieves comprehensive polarization and phase information from the backscattering signals, enabling impressive meter-level fiber cable sensor resolution.

As previously noted distributed acoustic sensing (DAS) systems have traditionally implemented a two-level distributed hierarchy: the Interrogator plus an edge computer. The Interrogator, containing a field programmable gate array (FPGA) processing unit, is tasked with handling data acquisition and preliminary digital signal processing. The resulting data is then transmitted to a higher-level computer for further analysis, including detection, pattern classification, and localization.

As a high throughput sensing system, the DAS is expected to function optimally. Yet, due to the limitations in FPGA hardware resources and the bandwidth of the data link between the computation units, the DAS system often resorts to down sampling the measurement results. This compromise significantly reduces the capability of the DAS for practical applications, and may even render it inadequate for new applications that demand high-definition data acquisition over long ranges.

Systems and methods according to the present disclosure address the inherent constraints of FPGA-based data processing in DAS systems, which include limited data throughput and latency, and suboptimal utilization of computational resources. As will be appreciated, one challenge is to develop a highly efficient, adaptable, and scalable system that can manage the intensive computational demands of real-time high-definition data processing from multiple channels effectively.

Conventional systems often face difficulties in synchronizing data transfer and processing, resulting in bottlenecks that hinder real-time analysis. Moreover, they lack the flexibility to dynamically adjust processing based on changing data volumes and computational resource availability. This is particularly critical in applications that require immediate data insights for decision-making, such as environmental monitoring, infrastructure management, and various fields of scientific research.

Therefore, systems and methods according to aspects of the present disclosure revolutionize the hierarchy of large-scale sensing systems by introducing a novel approach that circumvents the traditional data path from an analog-to-digital converter (ADC) card to a central processor (CPU). More specifically, instead employing a direct peripheral component interface express (PCIe) connection to graphics processing unit (GPU) random access memory (RAM), our inventive approach removes any need for data to pass through the CPU, facilitating data acquisition streaming and allowing for the real-time processing of significantly larger data sets.

By doing so, the system eliminates the bottleneck of limited FPGA buffer memory and the scalability issues associated with data transfer—and particularly network data transfer such as that over an Ethernet. With our new scheme, the DFOS system is no longer constrained by the limitations of user datagram protocol (UDP) connections over Ethernet, which previously restricted data transmission and reduced the definition of the output.

As we shall show and describe, previous FPGA designs, capable of handling 20,000 locations, is vastly outperformed by our new GPU-centric architecture, which can process and provide high-definition data for 300,000 locations. This scale of data processing was unattainable with the prior design and opens new avenues for DAS applications that require high resolution data over long ranges.

Our inventive arrangement not only circumvents the previous down sampling requirements but also sets a new standard for real-time DAS systems. The GPU-centric design enhances the DAS's functionality, enabling it to meet the evolving needs of environmental monitoring, infrastructure management, and scientific exploration with unparalleled precision and scalability

Accordingly, we believe our invention heralds a paradigm shift in real-time DFOS data processing by seamlessly integrating an Analog-to-Digital Converter (ADC) card with state-of-the-art GPU computational capabilities. Our inventive systems and methods effectively overcomes the limitations of data rate and latency posed by traditional FPGA-based methods, substantially increasing throughput and reducing processing times for complex spatial-temporal data streams.

Employing a dual-buffer, ping-pong style data retrieval strategy, our inventive systems and methods ensure unbroken data transfer directly into GPU memory via PCIe, negating the need for CPU intervention and the accompanying delays.

This redesigned, novel architecture substantially enhances the state-of-the-art by enabling the high-definition processing of an unprecedented number of data channels in real time, a critical capability for advanced applications such as large-scale infrastructure monitoring and sophisticated emergency response systems. The new approach, in bypassing previous constraints, enables the system to process data for up to 300,000 locations, a significant leap from the FPGA's 20,000. Such scalability, coupled with meticulous tuning of the GPU processing parameters, allows the invention to achieve processing speeds and efficiency never before possible, thereby establishing a new industry standard in the field of high-throughput data analysis.

The inventive features of our system that contribute to solving the problem of processing Distributed Fiber Optic Sensor (DFOS) data in real time include the following.

Integrated ADC Card and GPU Workflow: utilize a 4-channel ultra high speed ADC to simultaneously capture in-phase and quadrature components of two orthogonal polarization of back scattering optic signal from balanced photodetectors, namely xi, xq, yi, yq, respectively (we abbreviate as iq data for short afterwards), feeding it into a GPU-optimized data processing workflow for real-time analysis. This integration surpasses traditional FPGA capabilities, offering a more powerful and efficient processing method.

Dual-Buffer Ping-Pong Mechanism: Employs two pinned memory buffers in an alternating ‘ping pong’ mode to maximize data throughput. While one buffer is being processed by the GPU, the other is simultaneously being filled with new data, eliminating idle times and ensuring a continuous data stream.

GPU-Optimized Processing Kernels: Features custom-designed GPU kernels that process data in parallel, utilizing multiple streams to efficiently overlap communication with computation, dramatically reducing latency. To further accelerate the computations withing our GPU-accelerated system, we have adopted a strategy that separates complex number computations into their real and imaginary components. This allows the GPU to process these parts in parallel, exploiting its architecture to full effect and significantly boosting computations speeds. Additionally, we have integrated a special functions unit dedicated to calculating the atan2 function, which is essential for determining the phase information in our system. This unit is optimized for the rapid execution of this function, bypassing the more complex standard mathematical routines typically used, and therefore, reducing computation time.

This approach is particularly beneficial in a GPU context, where complex number computations traditionally require more time. In typical scenarios, operations to complex numbers involve multiple steps with interdependencies, which constrain the parallel processing capabilities of the GPU. By treating the real and imaginary parts separately and using a dedicated unit for complex mathematical functions, we minimize these dependencies, allowing more computations to occur simultaneously and reducing the overall processing time.

Dynamic Configuration Based on GPU Characteristics: Adapts the number of threads per block and block dimensions dynamically, optimizing the performance based on the specific characteristics of the GPU, which allows for precise tuning and maximization of computational resources.

Enhanced Data Analysis and Visualization Support: The system employs a multi-threaded approach, where each thread is specifically responsible for managing one of the buffers. This ensures efficient and parallel handling of data streams, with no cross-thread dependencies that could introduce latency. The multi-threaded architecture is crucial in supporting the advanced data analysis and visualization capabilities of the system, enabling it to process and utilize data in real-time applications. Such applications include machine learning algorithms for predictive analytics and detailed visualizations for complex decision support systems, all while maintaining the continuous, high-speed throughput required for real-time operation.

Together, these features represent a significant leap forward in real-time data processing technology, providing a solution that not only meets the current demands for DFOS applications, but also sets the stage for future advancements in high-speed data analysis.

Data Acquisition: The ADC card interfaces with the fiber optic sensors to capture real-time IQ data across multiple channels.

Buffer Allocation: Two pinned memory buffers are established, for efficient GPU access and data transfer. The buffers are configured to operate in a ‘ping pong’ mode for optimized performance.

Data Processing Initiation: The first buffer receives data from the ADC card while the second is used by the GPU for computation.

Parallel Processing by GPU: The GPU utilizes custom kernels to process the current buffer's data using massive parallel computing techniques. Multiple GPU streams are initiated to overlap data transfer and computation tasks.

Buffer Swap: Upon completion of processing for the current buffer, a swap occurs. The second buffer now becomes the active data recipient from the ADC, while the first buffer undergoes GPU processing.

Optimization & Tuning: Based on the GPU's characteristics, the system dynamically adjusts threads per block and block dimensions for optimal processing.

Output Preparation: Processed data is stored in dual and pinned output buffers as well, ready for further analysis, visualization, or decision-making processes.

Continual Loop for Real-time Analysis: The system continuously alternates between four pinned buffers (two for inputs, two for outputs), ensuring an uninterrupted flow of processed data.

This sequence of operations ensures that the GPU is constantly engaged in processing without waiting for data input, thus facilitating a non-stop data processing cycle conducive to real-time analytics and decision-making

A step-by-step description of the operation of our inventive systems and methods tailored for real-time data processing of Distributed Fiber Optic Sensor (DFOS) systems is as follows.

Initialization: The system initializes by setting up the ADC card to interface with the DFOS, ensuring that it's ready to capture the IQ data across the designated channels.

Memory Buffer Configuration: Two pinned memory buffers are established, each managed by a dedicated thread in a multi-threaded environment and configured for ‘ping pong’ operation. This setup optimizes access by the GPU, with one buffer actively receiving data while the other is simultaneously being processed. The distinct threads allow for an efficient and parallel workflow, reducing latency and enhancing the system's ability to handle high volumes of data in real-time. This multi-threaded management is instrumental in maintaining the seamless operation of the ‘ping pong’ mechanism, ensuring that each buffer is optimally utilized at every stage of the data acquisition and processing cycle.

Data Acquisition: The ADC card begins capturing real-time IQ data from the DFOS and sends it to the first memory buffer.

Processing Preparation: While the first buffer is being filled, the GPU prepares to process data by setting up the necessary computational kernels and streams.

First Processing Cycle: Once the first buffer is full, the GPU starts processing this data using parallel computation, while the second buffer simultaneously begins to collect new data.

Buffer Swap and Data Transfer: As the GPU processes the first set of data, the mutli-threaded system automatically switches to the second buffer to ensure a seamless data flow. The result of processed data is transferred to one of dual pinned output buffers.

GPU Optimization: The system dynamically adjusts the GPU processing parameters, including the number of threads and block sizes, to suit the GPU's specific capabilities for efficient processing.

Processed Data Output: The GPU completes processing the data in the first buffer, which is then transferred to the output buffers for further analysis, visualization, or immediate use.

Continuous Operation: The system operates continuously, with the buffers swapping roles after each cycle to maintain an uninterrupted data processing pipeline, allowing for real-time data analysis and decision-making.

Adaptive Processing: The system monitors processing efficiency and adapts the computational load as needed to optimize performance and maintain real-time operation.

This step-by-step process outlines the core functionality of our inventive systems and methods, emphasizing the continuous and efficient processing of data, optimized to the unique specifications of the GPU, ensuring real-time analysis capabilities for DFOS data streams

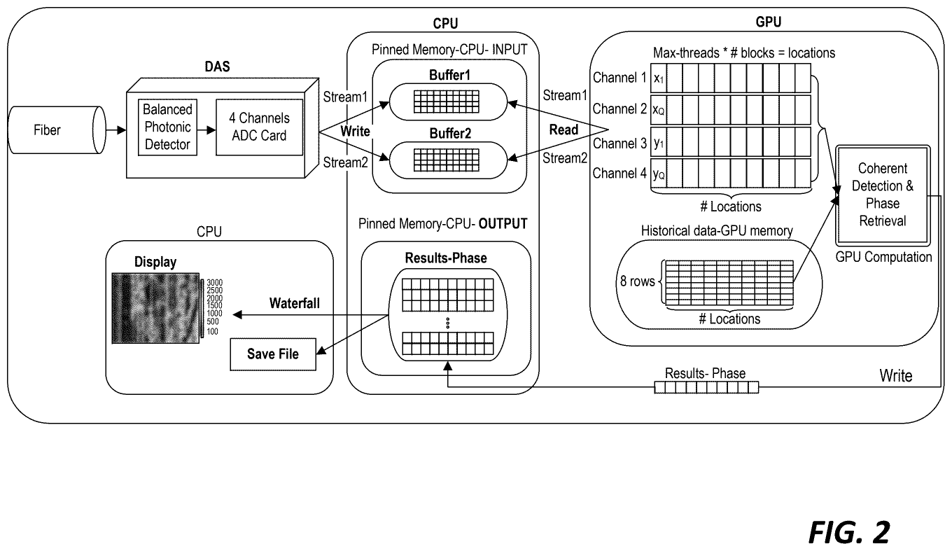

FIG. 2 is a schematic diagram showing an illustrative multi-threaded real time data processing system for DFOS including the integration of ADC with GPU-accelerated computation and dual-buffers “ping-pong” memory management for optimized throughput and latency according to aspects of the present disclosure.

A hierarchical feature diagram for the patent structure, starting with the broadest features down to the more detailed are as follows.

### Real-Time Data Processing System for DFOS

### 4 Channels ADC Card Integration

Direct capture of IQ data from fiber optics

Multi-channel support for comprehensive data acquisition

### Dual-Buffer Management

Pinned memory buffers for rapid GPU access.

Ping pong operation for continuous data flow

### GPU-Accelerated Computation

Parallel processing with custom GPU kernels

Multiple data streams for overlapping computation and transfer.

Dynamic adjustment of GPU threads and blocks

### Output Buffering and Analysis Support

Pinned output buffers for processed data.

Support for advanced analysis and visualization tools

Integration capabilities with machine learning algorithms

### System Performance Optimization

Real-time monitoring and adaptive processing load balancing.

Optimization feedback loop for continuous system improvement

Each level of this feature diagram represents a layer of the invention, from the core concept of a real-time data processing system to the specifics of GPU optimization techniques

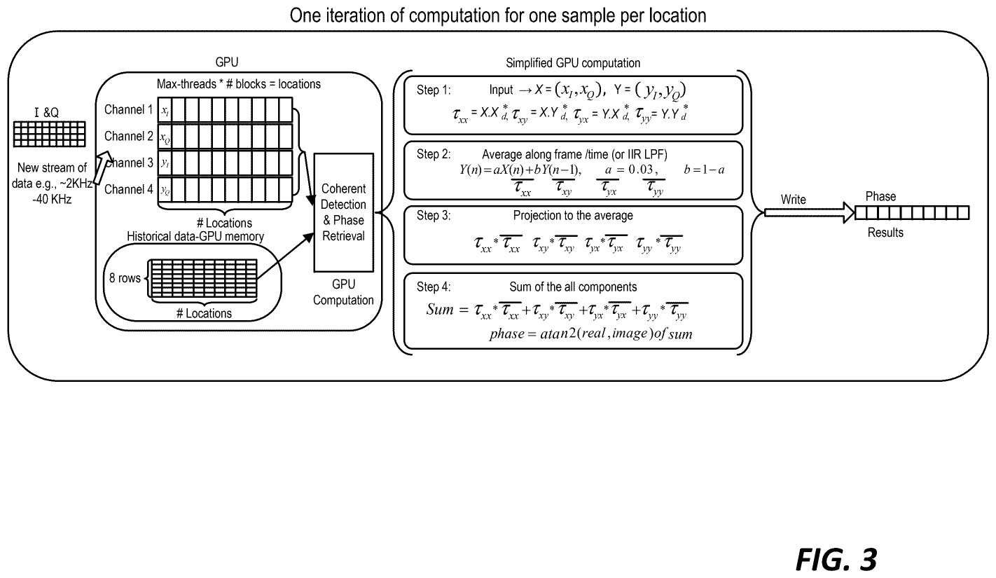

FIG. 3 is a schematic diagram showing illustrative one iteration of computation for one sample per location according to aspects of the present disclosure.

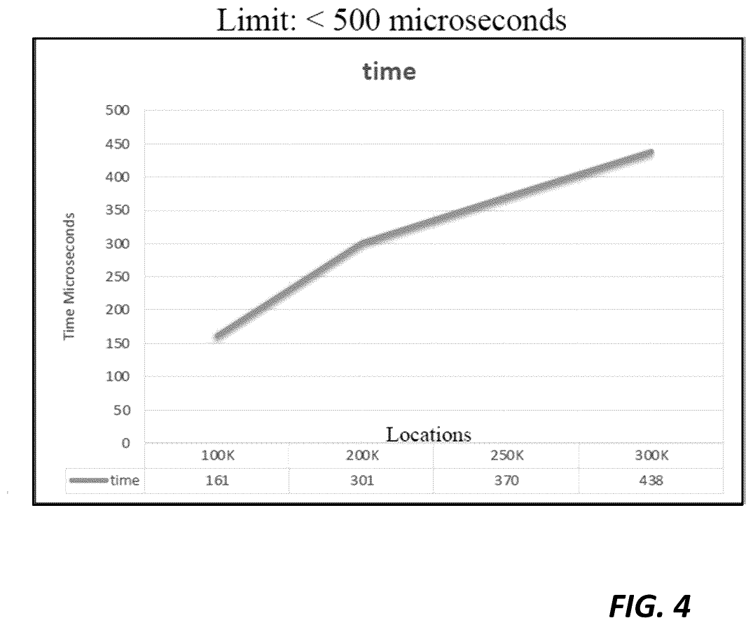

FIG. 4 is a plot showing illustrative results for systems and methods according to aspects of the present disclosure.

While we have presented our inventive concepts and description using specific examples, our invention is not so limited. Accordingly, the scope of our invention should be considered in view of the following claims.

1. A method for real-time processing in a distributed fiber optic sensor (DFOS) system, the method comprising:
initializing an analog-to-digital converter (ADC) card to interface with the DFOS system such that it is ready to capture IQ data across designated channels,
configuring memory buffers for “ping pong” operation,
capturing real time IQ data from the DFOS system and sending the captured data to a first memory buffer,
establishing, by a graphics processing unit (GPU), computational kernels and streams necessary for processing the IQ data,
processing, by the GPU using parallel computation, the IQ data in the first memory buffer when that buffer is full, while a second buffer simultaneously begins to store newly collected IQ data,
automatically switching, as the GPU processes the IQ data in the first memory buffer, processing the newly collected IQ data in the second buffer such that a seamless data flow is realized and the processed data is transferred to one of dual pinned output buffers,
transferring, by the GPU to output buffers for further analysis, visualization, or immediate use, processed data in the first memory buffer.

2. The method of claim 1 further comprising operating continuously with the two buffers swapping roles after each cycle to maintain an uninterrupted data processing pipeline.

3. The method of claim 2 further comprising monitoring, by the DFOS system, processing efficiency and adapting computational load as necessary to maintain a pre-determined performance level and real-time operation.
